(19) United States
(12) Patent Application Publication
(10) Pub. No.: US 2007/0062105 A1
(43) Pub. Date: Mar. 22, 2007

(54) Suntrap self-regulating solar greenhouse

(76) Inventor: Michael Maurice Stevens, Cleveland Heights, OH (US)

Correspondence Address: MICHAEL MAURICE STEVENS, 1935 COVENTRY ROAD, CLEVELAND HEIGHTS, OH, 44118-2001, US

(21) Appl. No.: 11/200,572

(22) Filed: Aug. 10, 2005

(51) Int. Cl. A01G 9/00

(52) U.S. Cl. 47/17

(57) ABSTRACT

A self-regulating solar-heated-and-cooled greenhouse consisting of a thermally-insulated opaque shell, generally formed by a floor supporting east, north, and west-oriented walls supporting a northerly-facing sloping roof, leaving the southern exposure of said shell “open”, said shell incorporating means of regulating the admission or expulsion of air to the greenhouse. Said “open” south face to be sealed-over by a solar energy collecting system comprised of two parallel light-admitting curtain-wall systems, generally vertical in orientation and planar in configuration, with a space between said wall systems forming an enhanced thermal break and of sufficient distance so as to effect periodic maintenance, and incorporating means of regulating admission or expulsion of air to the greenhouse. Said greenhouse further incorporating means of directing excess thermal energy collected during daylight hours into appropriate storage systems either within or without the confines of said greenhouse, and further incorporating means of providing insulation for the south-facing solar-wall systems at night or during inclement weather.

### BACKGROUND AND OBJECTS OF THE INVENTION

Commercial greenhouses have long provided a means for producing food crops and flowering plants in temperate-to-cold climate zones where seasonal changes greatly affect the propagation of green plants. Greenhouses were first constructed to shelter plants from temperatures below which they could not survive. As a part of increasingly sophisticated growing techniques, it was determined that large fluctuations in temperature had deleterious effects on propagation rates, as did lack of sufficient light levels and day-length. Current commercial greenhouse operations employ a wide variety of techniques to restrict temperature fluctuations within the greenhouse and also provide artificial lighting to supplement sunlight during late-fall, winter, and early spring. Problems inherent in the current “state-of-the-art” commercial greenhouse design, primarily variations of a polyethylene film-covered “tunnel” of rigid hoops, include rapid heat-loss at night or during inclement weather, necessitating the input of heat from fossil fuels and resulting in the largest single cost to the grower, lack of storage for excess thermal energy created during sunny days, thereby necessitating the “dumping” of excess heat to the outside, a wasteful endeavor, and the necessity of providing some method of partially covering the tunnel greenhouse on sunny days in late spring, summer and early fall to prevent the plants inside from “burning”. The present invention addresses all the above issues through built-in design features.

The present invention is a greenhouse structure that takes advantage of the constantly changing elevation of the sun relative to the horizon, and the constantly changing location of sunrise and sunset relative to the east-west axis of rotation of the Earth, to closely regulate the solar gain to the interior of the greenhouse, while providing effective means for retaining heat in the greenhouse and for directing excess generated thermal energy, collected on sunny days, into appropriate storage systems and extracting said stored energy as needed at night and during periods of inclement weather, thereby eliminating or greatly reducing the need for supplemental purchased energy. It is therefore the object of this invention to provide a self-regulating solar heated and cooled greenhouse. More particularly, an object of this invention is to provide a greenhouse-functioning structure utilizing a single transparent or translucent solar collecting wall system(s) generally facing generally south when said greenhouse is sited in the Northern Hemisphere, said solar collecting wall systems(s) facing generally north when said greenhouse is sited in the Southern Hemisphere, with the remainder of said greenhouse constructed of such materials as to form an opaque, thermally insulated shell, which shall provide for the prevention of penetration of unwanted direct solar rays during certain seasons of the year, provide for the retention of thermal heat energy within the confines of said greenhouse as desired and mutually provide for the exclusion of unwanted thermal energy at certain times of the year, provide for protection from the extremes of weather at all times, and provide certain means for the control of the introduction of outside atmosphere into the greenhouse and the expulsion of atmosphere from within the greenhouse to the outside environs.

These general objects, as well as other more specific objects of the invention, will be revealed in the following description and attached Views.

### DESCRIPTION OF THE DRAWINGS

FIG. 1 is a perspective view, from the south-east, of the preferred embodiment of the present invention and illustrates most, but not all, of the major components of said invention.

FIG. 2 is a cross-sectional view of the preferred embodiment of the present invention shown in Eig. 1, and illustrates all of the major components of the present invention.

FIG. 3 is a cross-section representational view of the preferred embodiment which illustrates the general path of incumbent direct winter sun rays in relation to the present invention.

FIG. 4 is a cross-section representational view of the preferred embodiment which illustrates the general path of incumbent direct summer sun rays in relation to the present invention.

FIG. 5 is a partial cross-sectional view of the preferred embodiment which illustrates an arrangement of moveable insulating means for the exterior and interior of the solar collecting wall system(s).

FIG. 6 and FIG. 7 are cross-section representational views of alternative geometries of the preferred embodiment, which may also fulfill the general requirements of the present invention.

FIGS. 8, 9, & 10 are perspective views, from the south-east and above, illustrating alternatives to the preferred embodiment of the present invention which may also fulfill the general requirements of the invention and may be constructed in a manner such that the “thermal shell” of the invention is formed as a single, continuous curvilinear unit, thereby having no distinct “east, west, or north wall(s) or roof. The preferred embodiment of the present invention is illustrated and explained with the aforementioned distinct walls and roof units for clarity, as proper east-west-north-south orientation of the structure is a crucial element of its functioning.

### SUMMARY OF THE INVENTION

A solar greenhouse is described having a floor. Joined to the edges of the floor, and supported above it, are walls and single-pitch sloped roof of thermally insulated, opaque construction, generally forming an open-sided enclosure or shell, with said open-side facing southerly when said solar greenhouse is sited in the Northern Hemisphere, and northerly when said solar greenhouse is sited in the Southern Hemisphere, said open-side sealed from the uncontrolled encroachment of the outside environs upon the interior environs of said shell by an arrangement of two distinct curtain-walls of light-admitting materials which allow for the admission of direct and indirect solar radiation rays into the interior environs of said shell, said curtains walls further incorporating means of allowing for the controlled exchange of atmosphere between the interior and exterior of said solar greenhouse. Said thermal shell of said solar greenhouse shall further incorporate means for the controlled exchange of atmosphere between the interior and exterior of said solar greenhouse. Said thermal shell of said solar greenhouse shall further support means of providing moveable thermal insulation for the exterior and interior of said solar curtain-wall systems. Said floor of said solar greenhouse shall incorporate means for the transfer of excess thermal energy generated inside said greenhouse to appropriate storage systems for retrieval at night or during inclement weather. As thermal storage systems vary widely, and will differ in construction and materials according to the siting and usage of said solar greenhouse, said thermal storage systems, while a vital component for the successful operation of said solar greenhouse, will not be described in the present invention except as a necessary “support” system. Examples of two possible thermal storage scenarios and the rationale for excluding a particular thermal storage method as part of the present invention will be described in “Method of Operation”. In the same manner, thermal insulation systems for night and inclement weather applications, which function to cover over the solar curtain-wall system(s), may vary widely according to local availability of methods and materials, therefore, one preferred method for performing said insulation function will be described as part of the preferred embodiment of the present invention, but said preferred method should not be construed to be the sole method of accomplishing said insulating function for the solar curtain wall system(s)

### DETAILED DESCRIPTION OF THE PREFERRED EMBODIMENT

Referring to the drawings and to FIG. 1, a perspective view from the southeast, discloses the basic design concepts of the solar greenhouse structure of the present invention. The floor 20 is bordered on three sides by a heavily insulated thermal shell 1, which, in the preferred embodiment, is formed of east and west trapezoidal walls, a short rectangular north wall, a large, rectangular sloping roof facing north at a 6/12 pitch, said floor 20 to be bordered on the fourth (south) side by tall solar curtain walls 2 & 2a, in the preferred embodiment of glass and appropriate support means, which extend from floor 20 to shell 1 (roof) and connect shell 1 (east and west walls), forming two distinct surfaces, generally planar and vertical, with an obvious separation 14 between outer solar wall 2 & inner solar wall 2a. The overall configuration of the structure is likened to a simple “shed” design, the geometry of said design being an essential element of the functionality of the invention. It will be further observed in FIG. 1 that solar walls 2 & 2a also include venting mechanisms 3 at the top extreme juncture with shell 1 (roof). It will be further observed that shell 1 rectangular north wall also includes venting mechanisms 3a at certain locations. Referring to FIG. 2, it will be observed that the space 21 between outer solar wall 2 and inner solar wall 2a, is not hermetically sealed, as would the “dead air” space between individual glazing panels of a “thermo-pane” window unit. The distance 14 between solar walls 2 & 2a is, at minimum, 24 inches, and could be larger dependent upon the overall scale of the present invention. This enables space 21 to function as a thermal barrier between solar walls 2 & 2a, and allows for entrance between the solar walls for periodic maintenance and repairs. Referring again to FIG. 1, in the preferred embodiment of the present invention, the ratio of the height 7 of the outer solar wall 2 to the depth 8 of the greenhouse floor 20 is generally 1:1, or equal, but this ratio is not fixed rigidly. The ratio of the height 7 of outer solar wall 2 to the height 10 of shell 1 (rectangular north wall) shall be optimally 2:1, when the present invention is sited at the 42nd parallel of North Latitude. In the preferred embodiment, following these basic ratios yields a shell 1 roof angle 11 of 27 degrees from the horizontal, which closely matches the inclination of the sun relative to the horizon at mid-day on December 21, the winter solstice, its lowest point during the calendar year. It will be noted here, and referring to FIGS. 6 & 7, that the thermal shell 1 of the present invention may be configured in alternative, but similar geometries, which include no formal “north wall, but may form a single continuous surface (FIG. 10). It is for this reason that, in description of the preferred embodiment, the thermal shell 1 is labeled a single component with varied parts (east, west, north, roof) because compass-orientation of the structure is vital to understanding the functioning of the present invention.

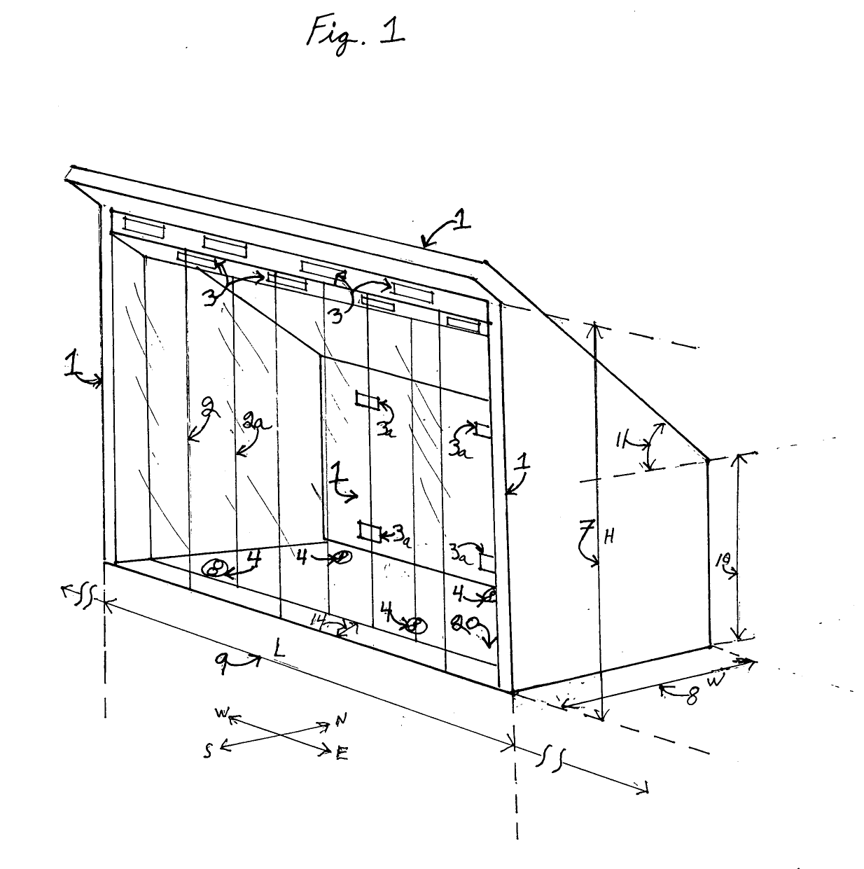

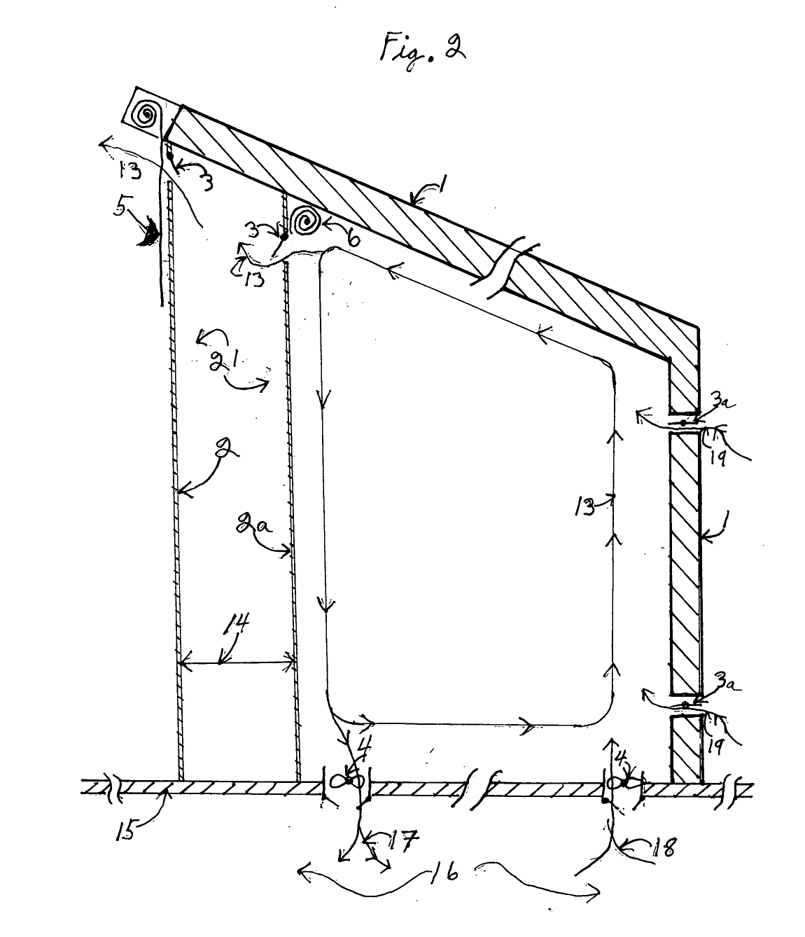

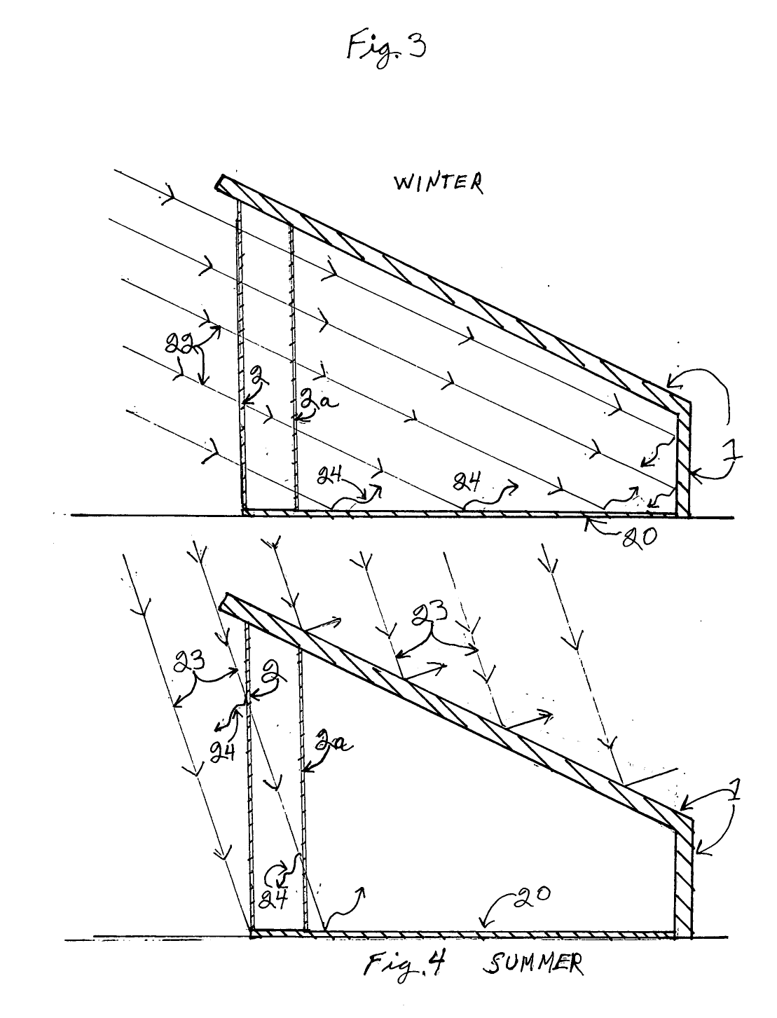

Again referring to FIG. 1, variations of the ratios of height 7 of outer solar wall 2 to depth 8 of floor 20, and height 7 to height 10 of shell 1 (north wall), allows for the shell 1 roof angle 11 to be adjusted to closely parallel the angle of the sun at winter solstice over the entire range of north or south Temperate-to-Cold Latitudes, where the present invention will find its' greatest utility. Again referring to FIG. 1, in the preferred embodiment, by closely matching the shell 1 roof angle 11 to the suns' winter solstice angle, several vital functions are maximized. Referring to FIG. 3, incumbent direct winter sun rays 22, penetrating solar walls 2 & 2a, embrace the northernmost reaches of floor 20 and portions of the inside surface of shell 1. Upon striking said surfaces or other objects within the greenhouse, a portion of the winter sun rays 22 are converted to heat energy 24, thereby warming said greenhouse. Referring to FIG. 4, it will be observed that during summer months, incumbent direct summer sun rays 23 are generally excluded from entering the interior of the solar greenhouse by two mechanisms. First, opaque thermal shell 1 blocks any entrance of direct rays 23, and the relatively extreme angle of incidence between incumbent direct rays 23 and vertical solar walls 2 & 2a serve to reflect a portion of said rays, further excluding them from entering said greenhouse. Therefore, the overall geometry of shell 1 relative to solar walls 2 & 2a is a crucial component of the present invention to regulate the amount of solar gain to the interior of the solar greenhouse during all seasons of the year and is a feature unique to the present invention.

Referring again to FIG. 1, the overall east-west dimension 9 of the preferred embodiment is, again, not rigidly fixed. A prototype of the present invention, in the preferred embodiment, has been constructed with an east-west dimension of thirty-six feet. In theory, east-west width 9 may extend for hundreds or even thousands of feet without adversely affecting the desired functionality of the solar greenhouse. This is because the cross-sectional geometry of the present invention, illustrated by FIGS. 2, 3, 4, 6, &7, is the controlling factor for proper function of the solar greenhouse, not the length of the structure. FIG. 2 illustrates this geometry which allows for the establishment and promotion of natural, convection-driven, interior air current movement 13, vital to the functionality of the design. Said air movement is generated thusly: referring to FIG. 3, incumbent winter sun rays 22 penetrate to the northernmost depths of the solar greenhouse and are changed to heat energy, thereby warming the air in close proximity thereof. Warmed air naturally rises upward from floor 20 and upon contact with inner surface of shell 1 roof, is generally directed upward and forward toward the south until it reaches the proximity of inner solar wall 2a, where, because solar wall 2a, while admitting solar radiation, is, in conjunction with outer solar wall 2, the least thermally insulated surfaces of the solar greenhouse, said inner surface of inner solar wall 2a is the coldest surface inside the solar greenhouse, whereupon said warmed air now begins to cool and fall toward floor 20 in an unobstructed path parallel to solar wall 2a. Upon reaching the proximity of floor 20, said cooled air begins a migration toward the northern extremes of the interior of the solar greenhouse, pulled along by the rising warmed air in proximity to said northern extremes, thereby completing convective loop 13. This natural convective pattern is dependent upon a thermal differential established by the relatively cold inner surface of inner solar wall 2a in opposition to the relatively warmer interior environs of the solar greenhouse, and the unobstructed geometry of the present invention illustrated variously by FIGS. 2, 6, & 7.

Referring again to FIGS. 1 & 2, it will be observed that greenhouse floor 20 is penetrated by a plurality of openings in certain locations in proximity to the northern and southern extremes of said floor 20. Said openings contain fan-induced venting mechanisms 4 which are preferably, but not necessarily, capable of bi-directional operation, and are for the purpose of directing excess solar-generated heat energy in the form of warmed air 17 into an appropriate heat storage system. Fan-induced vent mechanisms 4 will be thermally activated at prescribed points in the preferred embodiment. Heat storage will be discussed in “Method of Operation”, and, as many systems are available for said purpose, and, as said storage systems may be adapted to whatever site said solar greenhouse is erected upon, illustrations of a particular heat storage system will not be included as part of this patent application.

Referring again to FIGS. 1 &2, it will be observed that mechanical venting mechanisms 3 are, at specific locations, incorporated into the topmost extremes of solar walls 2 & 2a, and the shell 1 north wall also supports vent mechanisms 3a, in the preferred embodiment. These moveable, non-fan-induced vents 3 & 3a function to allow the exchange of atmosphere between the inside of the solar greenhouse and the external environs. Outside air 19 is admitted to the solar greenhouse for the purpose of thermal tempering and introduction of carbon dioxide-laden air needed for proper plant propagation. Overheated inside greenhouse air 13 may be released as needed as it follows the natural convective path upward along shell 1 roof and out through vents 3 located at the top of solar walls 2 & 2a. This convective path being established by the critical geometry established by the relationship of shell 1 and solar walls 2 & 2a as previously discussed. In the preferred embodiment, vents 3 & 3a will be thermally activated at prescribed points.

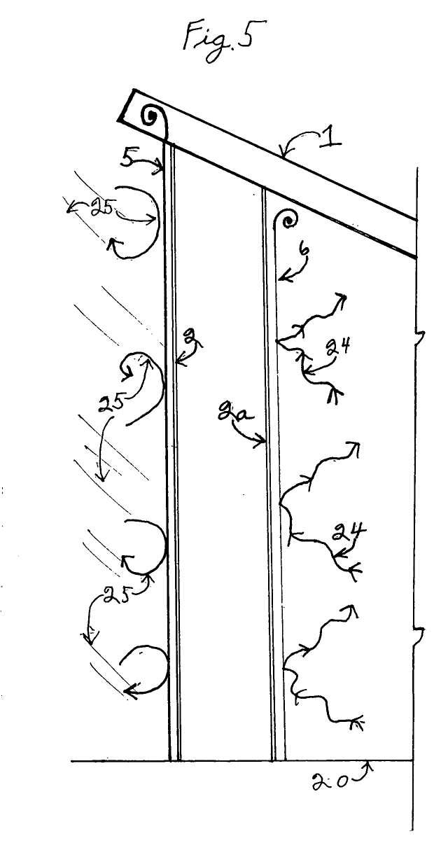

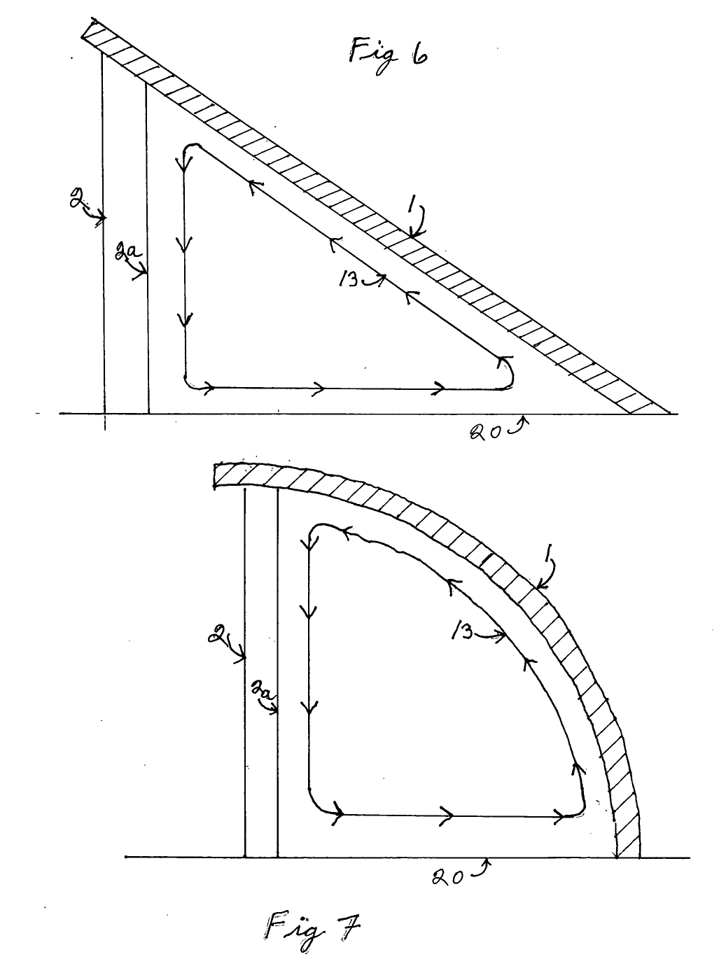

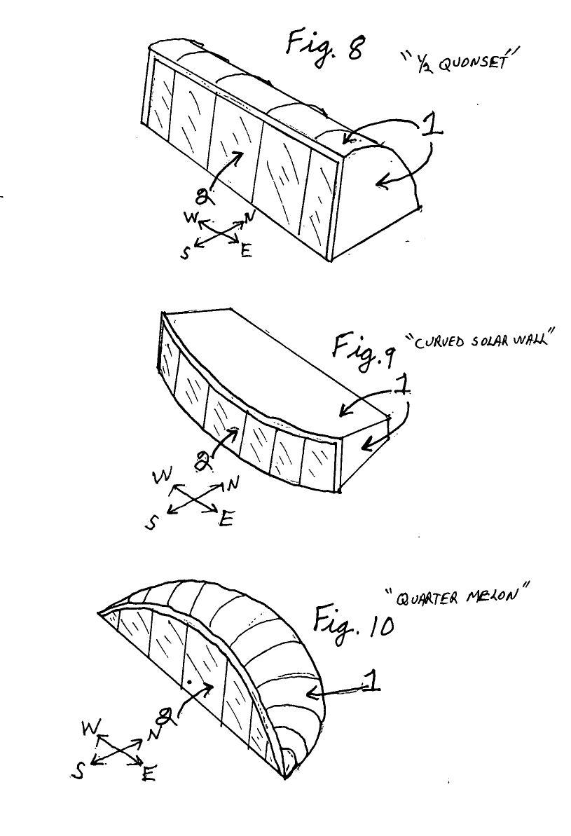

The final component of the present invention is observed by referring to FIGS. 2 & 5. Because the solar walls 2 & 2a are insufficiently effective at retaining thermal energy at night or during inclement weather as compared to thermal shell 1, a system of moveable insulation means is employed to augment the thermal barrier established by the space 21 between solar walls 2 & 2a. Referring to FIG. 2, it will be observed that positioned external to the juncture of outside solar wall 2 and shell 1 roof, and attached to said shell 1 roof, is the partially unfurled external thermal barrier 5, which, in the present invention, serves to completely cover-over and isolate the outside solar wall 2 from the extremes of temperature and weather 25, (FIG. 5), at night or during inclement weather. In the preferred embodiment, this thermal barrier 5 is comprised of a series of what are referred to in common usage as “rolling shutters”, assembled edge-to-edge, which are rolled up and stowed out of the way during daylight hours, and then unfurled and secured in place to cover the entire expanse of outer solar wall 2 at night or during inclement weather. Whatever method is employed to accomplish this function in the present invention should, optimally, completely isolate the outer solar wall 2 from the extremes of the outside environs when deployed. Many differing methods and materials may serve to fulfill this function, only one of which is illustrated in the preferred embodiment, and said illustrated method should not preclude any other method employed from protection of reach of this patent. In point of fact, the disclosure document submitted in anticipation of the present invention described an entirely different method of accomplishing the aforementioned function which was employed on the existing prototype and has been changed because of operational issues. Referring again to FIG. 2, it will be observed that interior moveable thermal barrier 6 occupies a position near the juncture of inner solar wall 2a and shell 1 roof. In this illustration, moveable inner thermal barrier 6 is fully retracted, as a rolled-up window shade might appear. Referring to FIG. 5, aforementioned moveable inner thermal barrier 6 is illustrated in the fully extended position, at which point, functioning in similar fashion to the outer moveable thermal barrier 5, also illustrated here fully deployed, it will completely cover and isolate the entire expanse of the inside surface of inner solar wall 2a from direct contact with warmed air inside the solar greenhouse. In the preferred embodiment, said thermal barrier 6 is fabricated of a metal-coated Mylar film, highly reflective in nature, deployed as a continuous series of edge-to-edge roll-up “shades” with edge guides for stability. This material has the ability to reflect up to 100% of long-wave infrared (heat) radiation incumbent upon it, is waterproof, tough and extremely thin, allowing long sheets to occupy minimal space when rolled-up. When fully deployed, FIG. 5, exterior moveable thermal barrier 5 and interior moveable thermal barrier 6, in concert with solar walls 2 & 2a, form a 4-layered barrier to prevent thermal energy loss from the interior of the present invention to the external environs.

Method of Operation (Northern Hemisphere)

Referring to FIG. 3, on sunny days in late fall, winter and early spring, sun rays 22, penetrate the south-facing solar walls 2 & 2a to the furthest northern extremes of the interior of the solar greenhouse. As previously discussed, this is due to the relatively low position of the sun relative to the southern horizon during these seasons. Specifically, Cleveland, Ohio, site of the prototype SunTrap solar greenhouse, is situated at approximately 42 degrees North Latitude, which yields an observed sun inclination of 27 degrees above the south horizon at noon on the winter solstice, December 21. Upon entering the interior environs of the solar greenhouse, the sun rays provide needed energy for the propagation of plants growing within, and a portion of said sun rays are converted to long-wave infrared heat energy by a process fully understood by the scientific community. This heat energy is “trapped” within the SunTrap solar greenhouse firstly by the heavily thermally insulated shell 1 and secondly by solar walls 2 & 2a by the process well known to the scientific community as the “greenhouse effect”, whereby visible light energy, which easily penetrates a glazing medium, in the preferred embodiment clear tempered glass, is transformed to longer-wavelength infrared-spectrum heat energy upon striking physical objects, which is then resisted from re-transmission out through the glazing medium, again by a process fully understood by the scientific community. In this mode of operation, venting mechanisms 3, 3a & 4 are generally fully closed and sealed. As the temperature within the solar greenhouse rises to predetermined levels, fan-induced vent mechanisms 4 are activated to transfer excess solar-generated heat to an appropriate storage system, which may or may not occupy space within the greenhouse and is dependent upon factors including siting, function of the greenhouse and function of the storage. Two examples of such storage systems/methods will be cited here in explanation for the rationale of the inclusion of such systems as vital to the successful operation of the SunTrap solar greenhouse, and for the exclusion of any particular thermal storage system as a component of the present invention.

In the first example, referring to FIG. 2, the solar greenhouse of the present invention has been installed directly atop the flat roof structure 15 of an existing commercial building, such as a Wal Mart, Home Depot, supermarket, mall, ect. This presumes, of course, that the roof structure 15 is capable of sustaining the live load imposed by the greenhouse and its contents. Rather than store excess solar-generated thermal energy in bulky, high-mass (heavy) storage media such as water, rock, phase-change salts, or the like, which would require a heavier, stronger roof design, excess heat laden air 17 from inside the solar greenhouse is directed by fan-induced vent mechanisms 4 into the occupied space of the building below, either directly or through appropriate ducting, providing heat and reducing the load on the buildings' environmental conditioning systems during sunny days in cold weather. Conversely, at night or during inclement weather, warm air 18 from the building below is introduced to the rooftop solar greenhouse through fan-induced vent mechanisms 4 to maintain the necessary temperature range for successful propagation of the crops therein. As the SunTrap solar greenhouse is designed to be better insulated than standard commercial roof structures, siting a SunTrap solar greenhouse on the roof should result in a net energy gain for the commercial structure below. Additionally, in summertime, Overheated air 13 is allowed to escape from the greenhouse through vent mechanisms 3 at the top of solar walls 2 & 2a, and this process, in conjunction with proper use of fan-induced vent mechanisms 4, will provide a very low energy method of exhausting heated air from the commercial structure below, reducing the load on the buildings' air conditioning systems. Additionally, carbon dioxide, exhaled by the occupants of the commercial building, and introduced into the SunTrap greenhouse with return air 18, is necessary for proper plant propagation. In this example, the entire building upon which the SunTrap is sited functions as the thermal storage system. In the second example, the SunTrap greenhouse is constructed on the ground, in the manner of conventional greenhouses. In this application, the floor 20 could be of concrete, underneath which is an insulated chamber of some sort, possibly constructed of assembled cinder block, configured in such manner as to allow for the free flow of air 17 driven by fan-induced vent mechanisms 4 through and around said blocks, which provides storage of heat energy in its quantity of mass, and then may release that same energy 18 back into the greenhouse, again by fan-induced vent mechanisms 4, as required. Alternatively, cinder blocks or the like may be used in a ground-based scenario to construct growing tables and fixtures inside the greenhouse, adding large quantities of mass directly inside the greenhouse but occupying valuable floor space. It must be understood, therefore, that while a suitable heat storage system is essential for the effective, most energy efficient, operation of the SunTrap solar greenhouse, any particular heat storage is not to be construed as the only method applicable to the present invention. This may be likened to a water-cooled internal-combustion engine, the design of which may be patentable, and this same engine will indeed start and function without some method of removing heat from the water which cools it, i.e. a radiator, which would probably not be a part of the patent sought, but said engine won't function very well and it won't function very long.

Generally, the thermal storage system should be sized to absorb all the excess thermal energy generated within the SunTrap solar greenhouse on a sunny day. Should circumstances occur whereupon the temperatures within the solar greenhouse continue to rise beyond designated parameters, which may occur upon a mechanical failure of fan-induced vent mechanisms 4, a secondary temperature-controlling method may be engaged. Referring again to FIG. 2, the vent mechanisms 3, located near the top of solar walls 2 & 2a, may be opened in reaction to elevating temperatures, creating a pathway for convective air currents 13 to escape the internal environs of the solar greenhouse, through natural updraft mechanisms, and take overheated air to the external environs of the solar greenhouse. This natural updraft-to-exit opportunity is created by the particular placement of vent mechanisms 3 at juncture of the upwardly sloping shell 1 roof and vertical solar walls 2 & 2a. Additionally, should full-venting operations of vent mechanisms 3 located in solar walls 2 & 2a fail to control rising temperatures within the solar greenhouse, vent mechanisms 3a, situated in the shell 1 north wall, may be opened to introduce cold, outside air directly into the internal environs of the solar greenhouse. In the preferred embodiment, the combined operation of all vent mechanisms 3& 3a and fan-induced vent mechanisms 4, will enable very rapid changes of the entire air volume within the greenhouse, enabling control of internal temperatures regardless of external conditions.

In prescribed seasons, at sundown, or at times when solar gain is insufficient to contribute significantly to the growth of plants or to the creation of internal heat, the nighttime/inclement weather mode of operation commences. At this juncture, all venting mechanisms 3 & 3a will close and seal. Fan-induced vent mechanisms 4 may or may not operate, as determined by pre-set parameters. Moveable thermal barriers 5 & 6 will deploy to cover and seal solar walls 2 & 2a (FIG. 5), thereby forming a four-layered barrier to the transmission of thermal energy from the interior of the present invention to the exterior environs. As internal temperatures drop to pre-determined levels, fan-induced vent mechanisms 4 may be activated in such mode as to retrieve stored thermal energy from the thermal storage system. This nighttime/inclement weather mode of operation will continue until the next point at which solar gain is sufficient to contribute to the successful function of the SunTrap solar greenhouse, usually shortly after dawn of the next day, at which point moveable thermal barriers 5& 6 will be moved to their respective stored positions and the solar gain cycle will start to illuminate and warm the inside of the solar greenhouse. It is anticipated that, under extreme conditions, supplemental lighting and heat may be employed to maintain good propagation of plants within the greenhouse.

Method of Operation: Summer

Referring to FIG. 2, during the late spring, summer and early fall months, when nighttime or inclement weather conditions do not include variations in temperature which may adversely affect the propagation of plants located within the present invention, It may not be necessary to deploy moveable thermal barriers 5& 6. Venting mechanisms 3 & 3a will continue to be utilized to admit or release volumes of air as needed to maintain prescribed conditions of temperature, humidity, and atmospheric gas content to the interior of the SunTrap. Fan-induced vent mechanisms 4 may be employed now to introduce “coolth” or cooler air circulated into the thermal storage system at night or on cool days, for retrieval at such time it is necessary to reduce the temperature inside the present invention.

Referring to FIG. 4, while thermal shell 1 prevents incumbent direct sun rays 23 from entering the interior of the present invention when the sun is high in the sky relative to the horizon, solar walls 2 & 2a admit a small profile of direct sun rays 23 to the southernmost area of the floor 20. The large glazing areas of solar walls 2 & 2a do, however, allow for the admission of indirect sun rays (not illustrated), much less intense in their energy, but capable of producing good propagation of a wide variety of shade-tolerant plants, which may be cultivated successfully within the confines of the present invention, enabling its' profitable use on a year-round basis.

It will therefore be understood, that the present invention incorporates unique features which promote or inhibit the admission of solar energy as desired in concert with the changing of the seasons, said features to include the thermal shell 1, solar walls 2 & 2a, thermal barriers 5 & 6, geometry of cross-section (FIGS. 2, 5, 6), venting mechanisms 3, 3a, of specific placement within the structure, and fan-induced venting mechanisms 4 for the transfer of thermal energy into and out of the invention as required. The solar walls 2 & 2a of the preferred embodiment are constructed of glass with suitable support means so as to form a rigid, durable unit. Many alternative light-admitting materials, such as polyethylene film, vinyl film, Lexan, plexiglass, ect. are also suitable for the above stated function. The thermal shell 1 may be constructed of a very wide variety of materials and methods, including structural insulated panels (SIPS), spray-applied urethane foam over a suitable form, fiberglass or batt insulation between studs and interior/exterior sheeting, or even strawbale methods.

While the present invention has been described with a certain degree of particularity, it is discernable that numerous variations in the construction of and arrangement of the various components of the present invention are possible without deviation from the spirit and scope of this disclosure. It is understood that the present invention is not limited to the preferred embodiment described herein, but is to be limited only by the scope of the attached claim or claims, and shall include the full range of equivalency to which each element thereof is entitled.

I claim:

1) A self-regulating solar heated and cooled greenhouse structure incorporating a south-facing solar-energy collecting system comprised of two, separate light-admitting glazed curtain-wall systems, generally vertical in orientation and planar in configuration, and separated from one another by a distance sufficient to substantially inhibit thermal energy transfer from within said greenhouse to the external environs.
An opaque, thermally insulated shell to comprise the remaining walls and roof of said greenhouse, and configured in such a manner as to promote natural convection air circulation patterns within said greenhouse at all times, and further configured in such manner as to allow for the penetration of direct sun rays to the northernmost reaches of said greenhouse floor and inner walls during late fall, winter, and early spring, while simultaneously inhibiting the penetration of direct sun rays during late spring, summer and early fall, thereby providing an automatic modulating effect on the solar-gain properties of said greenhouse in all seasons. Means for directing excess collected solar thermal energy into appropriate storage systems and for the extraction of said stored energy as needed to maintain pre-determined temperatures within said greenhouse, and means for regulating the admission or expulsion of atmosphere to said greenhouse.

2) A self-regulating solar greenhouse according to claim 1 incorporating a moveable thermal barrier system capable of completely covering and isolating the outside of the external south-facing solar wall system from the external environs at night, during inclement weather or at any such time as deemed necessary.

3) A self-regulating solar greenhouse according to claim 1 incorporating a moveable thermal barrier system capable of completely covering and isolating the inside of the internal south-facing solar wall system from the balance of the interior of said greenhouse at night, during inclement weather or at any such time as deemed necessary.

4) A self-regulating solar greenhouse according to claim 1 which provides regulated light levels inside said greenhouse according to relative distance from aforementioned solar wall system(s) and season of the year.
